(19) United States
(12) Patent Application Publication
(10) Pub. No.: US 2016/0194079 A1
(43) Pub. Date: Jul. 7, 2016

(54) Method of automatically piloting a rotary-wing drone for performing camera movements with an onboard camera

(71) Applicant: SQUADRONE SYSTEM, Grenoble (FR)

(72) Inventor: Sylvain Montreuil, Annecy (FR)

(21) Appl. No.: 14/985,979

(22) Filed: Dec. 31, 2015

(30) Foreign Application Priority Data
Jan. 2, 2015 (FR) 1500002

(51) Int. Cl. B64C 39/02; G05D 1/00; G05D 1/10; B64D 47/08

(52) U.S. Cl. CPC B64C 39/024; B64D 47/08; G05D 1/0011; G05D 1/102; B64C 2201/127

(57) ABSTRACT

The object of the invention is an autonomous piloting method, by means of a base station, for a rotary-wing drone with multiple rotors, for controlling the drone in attitude and in velocity following a selected camera movement and a position of the subject to be filmed. The method comprises the following steps:
1. Selection by the user of a camera movement (6) defined by a set of parameters comprising: image shooting mode in a fixed or moving point (7); type of a movement in attitudes relative to the subject to be filmed (8); displacement velocity; displacement directions or axes; direction of the displacement (10); image shooting altitudes (9);
2. Generation of commands for positions (15) through which the drone will have to pass, from the said set of parameters (12) and from the instantaneous position of the subject to be filmed (13) as well as from its recent trajectory (14);
3. Activation of the image shooting by the video camera once the drone is launched on the positions sent by the onboard base station on the subject.

The device according to the invention is particularly intended for the taking of aerial views.

### FIELD OF THE INVENTION

The invention relates to systems for controlling rotary-wing drones such as quadricopters, hexacopters and the like.

### BACKGROUND OF THE INVENTION

These drones are provided with multiple rotors driven by respective motors which may be controlled in a differentiated way in order to pilot the drone in attitude and in speed. These drones are piloted by the user by means of a remote control device—hereafter designated by the term of “base station”—connected to the drone through a radio link.

A typical example of such a system is the IRIS from 3D Robotics, USA, which is a quadricopter equipped with a series of sensors (accelerometers, three-axis gyrometers, barometer, GPS), with a camera stabilizing system, with a camera capturing an image of the scene towards which the drone is directed, with an RC (remote control), and with a smartphone or tablet application with a piece of base station software communicating with the drone via a radio link. More specifically, one of the navigation modes of the drone is called an automatic mode. In this mode, the drone is directed by the user by means of the base station which may be a computer, a smart phone equipped with base station software, a multimedia tablet of the iPad (registered trademark of Apple Inc, USA) type, or any other connected object by sending positions through which the drone has to pass. These passage points are GPS coordinates and an altitude which are predefined before the flight of the drone.

The user manually defines the passage points of the drone through the base station or else by programming them before the flight of the drone so as to have an influence on the behavior of the drone.

Another navigation mode is called a manual or assisted mode. In this mode, the drone is piloted by the user by means of signals emitted by a remote control which will be expressed by the drone as movements. For example, to have the drone move forwards, the user tilts the pitch joystick upwards. In this way, the drone is controlled so as to tilt or dive downwards (a tilt according to a pitch angle), it will advance forwards with a higher speed since the tilt will be substantial. Conversely, if it is controlled so as to nose up in the opposite direction, its speed will gradually slow down and then be inverted upon starting again backwards. In the same way, for a tilting command along a roll axis, the drone will tilt rightwards or leftwards, causing a linear horizontal translational displacement to the rights or to the left.

The navigation techniques mentioned unfortunately are not or not very applicable for capturing a video image by means of the camera on a fixed or moving subject for the particular reasons mentioned here:
1. insofar that the drone is piloted manually, the taking of a viewpoint relatively to a subject is a delicate operation requiring great dexterity and very good experience in piloting drones, and is therefore not accessible to a public of neophytes or amateurs;
2. the use of the automatic navigation mode requires preparing a flight plan beforehand and therefore does not give the possibility of being reactive towards a behavior of the moving subject which is undefined beforehand.

### BRIEF DESCRIPTION OF THE INVENTION

The problem of the invention is to find another technique for controlling drones which gives the possibility of producing a sequence of video images on a fixed or moving subject without having to intervene manually or automatically on piloting of the drone.

The basic idea of the invention consists of using an onboard base station on the subject to be filmed which may autonomously communicate with the drone in order to produce a sequence of video images. For this, the user selects a camera movement from within a library on the base station application which automatically defines for the drone a corresponding trajectory and depending on the position of the subject adapted for taking the selected shot. The subject may then start to move, the drone control system adapting automatically to the new positions of the subject number.

So-called “follow-me” technical solutions which have the purpose of facilitating the shooting of an image relative to a moving subject have been developed recently, the shots only being in a relative position with respect to a moving subject bearing a base station. The invention differs from these solutions by the fact that the purpose is to perform a camera movement around the moving subject and not only to have a relative position for following the subject. These camera movements may be basic and inspired from the cinematographic world (travelling, dolly, crane, . . . ) or much more complex, involving sequences of basic movements, which may be described as in FIG. 6.

More specifically, the object of the invention is a method for autonomously piloting, by means of a base station, a rotary-wing drone with multiple rotors, for piloting the drone in attitude and in speed following a selected camera movement and a position of the subject to be filmed. The drone includes a video camera loaded onboard capable of capturing a sequence of images of a target as seen from the drone and of transmitting this sequence to the base station.

The invention notably deals with the anticipation of the position of the subject to be filmed and of the position of the onboard video camera for performing the camera movement(s) selected by the user.

In a characteristic way, this method comprises the following steps:
1. Selection by the user of a camera movement defined by a set of parameters comprising: shooting mode on a fixed point or in motion; movement type with attitudes relative to the subject to be filmed; displacement speed; displacement directions or axes; displacement direction; shooting altitudes;
2. Generation of commands of positions through which the drone will have to pass from said set of parameters and from the instantaneous position of the subject to be filmed as well as from its recent trajectory;
3. Activation of the shooting by the video camera once the drone is launched on the positions sent by the onboard base station on the subject.

### BRIEF DESCRIPTION OF THE DRAWINGS

An exemplary application of the device of the invention will now be described, with reference to the appended drawings wherein the same numerical references refer to identical or functionally similar elements from one figure to the other.

FIG. 1 is an overall view of the system showing the drone, a remote control and the base station allowing it to be flown.

FIG. 2 is an exemplary application of a base station on a smartphone use for automatic missions by pre-programming GPS coordinates through which the drone has to pass.

FIGS. 3 and 4 are examples which illustrate how to navigate within a library of movements and how to define the corresponding set of parameters.

FIG. 5 describes the application of the invention by which the automatic control of the drone is ensured through a selected camera movement and related parameters, and of the position of the subject to be filmed.

FIG. 6 describes an exemplary composition of camera movements.

### DETAILED DESCRIPTION OF EMBODIMENTS OF THE INVENTION

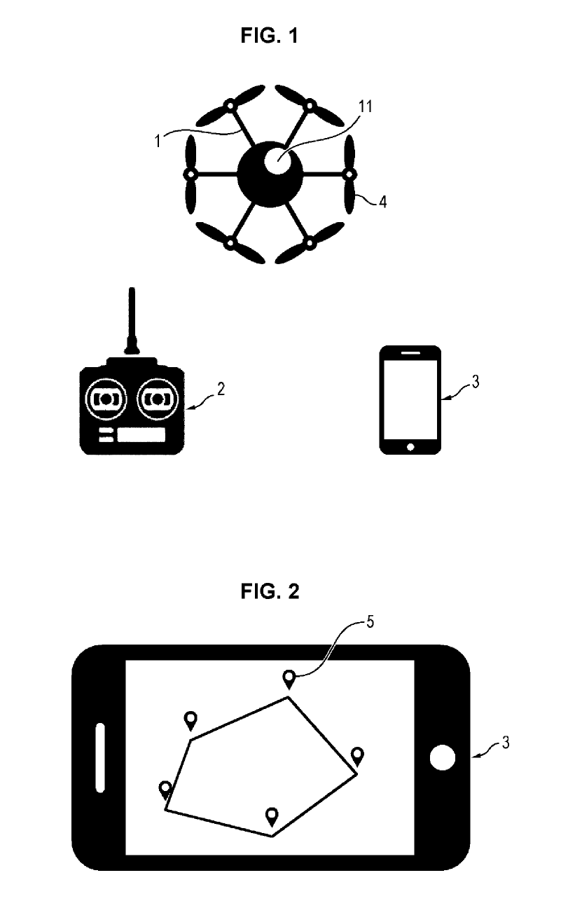

In FIG. 1, reference 1 generally designates a drone, which is for example a hexacopter. This drone includes six coplanar rotors 4, the motors of which are controlled independently by an integrated navigation and attitude control system. The drone 1 also includes a front camera 11 giving the possibility of obtaining an image of the scene towards which the drone is directed.

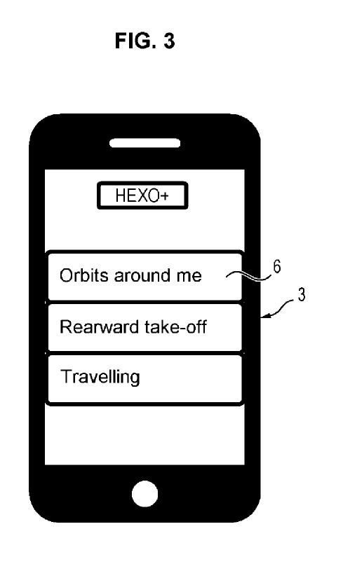

The drone may be piloted by a distant remote control 2 or by a base station 3. In FIG. 1, the base station illustrated as an example is a smartphone 3 equipped with a suitable application. This base station 3 may also be a tablet, a multimedia walkman or any other connected apparatus provided with a touchscreen, with means capable of detecting at least contact of one finger of a user at the surface of the screen, and with radio link means with the drone allowing bidirectional exchange of data: from the drone 1 to the base station 3 notably for the position of the drone and the transmission of the image captured by the camera 11, and from the base station 3 to the drone 1 for sending piloting commands. FIG. 2 represents an example of a preprogrammed mission on the base station 3 in an automatic mode with GPS coordinates 5 through which the drone will pass. A passage altitude is associated with these coordinates in presently available systems.

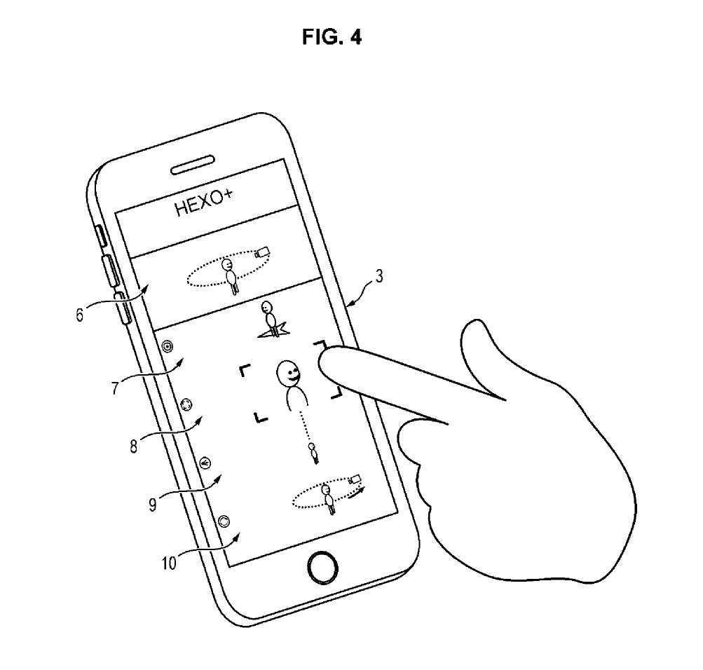

In FIG. 3 is illustrated an example of the base station 3 application on a smart phone giving the possibility to the user of navigating within a library of camera movements 6. The user may thus select the type of viewpoints and camera movement which he/she desires—these are camera movements may be basic or complex, and may optionally be programmed so as to be successively performed either from a user action, or from an elapsed time, or from a covered distance.

In FIG. 4 is illustrated an example of details on the base station 3 on a smartphone giving the possibility for a given camera movement 6 of specifying a certain number of parameters related to the movement desired by the user. The camera movement given as an example here is a 360° selfie. In this example, these parameters are: the relative position of the camera with respect to the subject 7 in a horizontal plane, a relative distance 8 of the camera with respect to the subject allowing the user to select the desired type of plane, the desired time-dependent change in altitude 9 of the camera giving the possibility of obtaining an aerial viewpoint on the subject to be filmed and the speed and the direction of rotation 10 of the camera around the subject.

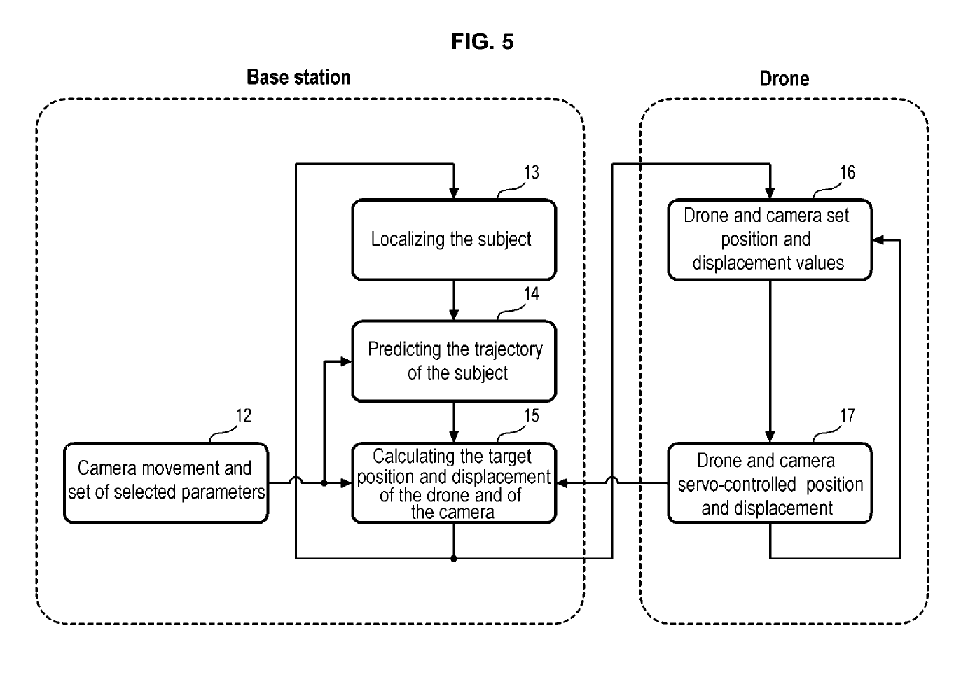

In FIG. 5, we describe in detail the steps for applying the invention. From the camera movement and the set of parameters 12 selected by the user on the base station, the position of the subject is evaluated at regular intervals 13 from the sensors loaded onboard the latter. These sensors may be bound to the base station, to the multimedia apparatus hosting this application or to a device dedicated to localizing the subject. The localization of the subject 13 is accomplished through the hybridization of data from various sensors, some of which may for example be: a GPS sensor, an inertial unit containing three accelerometers, three gyroscopes, three magnetometers and a barometer. The localization of the subject is accomplished either in a two-dimensional plane (horizontal plane) or in a three-dimensional plane if the sensors allow this.

From localization data of the subject 13 thereby collected at regular intervals, a mechanism for predicting the trajectory of the subject 14 is applied in order to evaluate the estimated trajectory of the subject to be filmed. The elements taken into account for predicting the trajectory may depend on the type of camera movement and on the set of selected parameters 12 and may be more or less complex depending on the types of available sensors and on the intended accuracy. A simple example for predicting a trajectory may be achieved by means of a velocity vector (direction/course velocity pair) of the subject which is applied to its present position in order to estimate its future position and its movement over time. The purpose is to anticipate the position of the target depending on its velocity. The measurement of the velocity of the target is carried out by measuring the distance covered by the target for a given elapsed time. This measurement should be carried out at a sufficient frequency so that the drone reacts sufficiently rapidly but not too rapidly either so that the measurement is sufficiently accurate. If it is considered that the GPS position is accurate to within one meter and that it is desired to move with a velocity varying from zero to ten m/s, an interesting compromise might be conducting a velocity measurements every second.

The predicted position of the subject then allows definition of the target position of the drone for the future instant as well as the parameters of its displacement 15. These parameters are for example the horizontal displacement velocity, the vertical displacement velocity, the rotational velocity of the drone. The target position is typically a GPS points, an altitude and a desired orientation for the drone at a given instant. The orientation of the camera on the pitch axis is also part of the target position so that the axis of the camera is always in the direction of the subject to be filmed and that the latter is framed. This calculation of the position and of the displacement elements of the drone also depends on the movement of the camera and on the set of selected parameters 12 as well as on the position and on the attitudes of the drone 17.

This target position and the displacement elements are transmitted as set values to the drone 16 via a communications procedure and a radio link allowing communications between the drone and the base station. This radio link may for example be a wireless link of the Wi-Fi (IEEE 802.11) or Bluetooth (trademarks) local network type. The communications procedure allowing transmission of these set values from the base station 3 to the drone 1 may for example be a standardized procedure like the MAVLINK protocol elaborated by the ETH Zurich, Switzerland.

These position and displacement set values are then taken into account by the flight controller of the drone which will actuate the controllers for driving the coplanar rotors 4 which will cause displacement of the drone towards the target position. A servo loop 17 is then executed for correcting the actual trajectory of the drone according to the target trajectory.

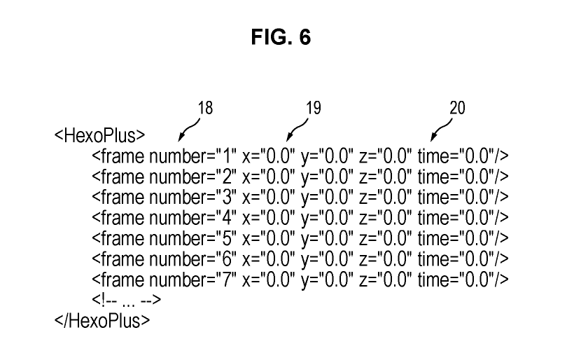

The whole of this process is iterated at regular intervals. The frequency of this process may typically be 10 Hz, and varies according to the types of sensors and to the selected camera movement type 12. In FIG. 6, a camera trajectory or movement is described with a set of “frame” beacons 18. Each frame has a unique identifier 18, of a position relative to the target position of the drone on a 3D plane (x,y,z) 19 and of a time which corresponds to the passage instant of the drone through said target position 20.

1. A method for piloting a drone by means of a remote control device, this drone being equipped with a video camera, the device, here called a base station, being a portable device comprising: a touchscreen; onboard or remote sensors for localizing a subject to be filmed, and means for wireless transmission of data, capable of emitting commands intended for the drone;
this method comprising the following steps:
selection by the user of a camera movement defined by a set of parameters comprising:
shooting mode in a fixed or moving point; type of displacement in attitudes relative to the subject to be filmed; displacement velocity; displacement directions or axes; displacement direction; image shooting altitudes;
generation of commands for positions through which the drone will have to pass, from said set of parameters and from the instantaneous position of the subject to be filmed as well as from its recent trajectory;
activation of the image shooting by the video camera once the drone is launched on the positions sent by the onboard base station on the subject
wherein:
a. the drone automatically moves according to the trajectory of the subject and to the prediction of its trajectory,
b. in order to perform a predefined camera movement associated with a set of parameters,
c. the calculation of the position and of the displacement elements of the drone both depend on the camera movement to be achieved, on the position of the subject to be filmed and on the localization and attitudes of the drone.

2. A method for representing a camera movement of a camera borne by a drone relative to the position of a subject followed by said drone, wherein:
said camera movement is described with a set of “frame” beacons,
each frame has a unique identifier of a position relative to a target position of the drone on a 3D plane and of a time which corresponds to the passage instant of the drone through said target position.

3. The method according to claim 1, wherein:
the user selects by means of a graphic interface a camera movement which he/she wishes to perform, from a library,
the user defines a set of parameters relative to this camera movement in order to define the relative position of the camera with respect to the subject in a horizontal plane, a relative distance of the camera with respect to the subject allowing the user to select the desired type of plane, the desired time-dependent change in altitude of the camera for having an aerial viewpoint of the subject to be filmed and the velocity and direction of rotation of the camera around the subject.

4. The method according to claim 1, wherein a camera movement and the set of associated parameters are achieved by the drone by means of commands sent by the base station after having evaluated the localization of the subject from onboard sensors on said subject, predicted its trajectory and calculated the position and the target displacement elements of the drone from the localization and from the predicted trajectory of said subject so that the axis of the camera is directed towards the subject to be filmed and that said subject is framed.

5. The method according to claim 4, wherein the drone moves to a recorded set target point depending on the position and on the displacement of the subject to be filmed and on the camera movement to be achieved.

6. The method according to claim 4 wherein the orientation of the drone (yaw) and the tilt of the camera (pitch axis) are subordinated to the subject according to its position and to its relative displacement to the drone.

7. The method according to claim 4 wherein the drone is altitude-controlled depending on the altitude of the subject and on its vertical displacement.

8. The method according to claim 2 wherein the description of the trajectory by means of beacons is used with the sets of parameters for calculating the position and the target displacement elements of the drone.

9. The method according to claim 5, wherein the trajectory of the drone is corrected by means of a servo-control loop according to the position and the target displacement elements of the drone calculated from the localization and from the predicted trajectory of said subject.
